(19) United States
(12) Patent Application Publication
(10) Pub. No.: US 2017/0177641 A1
(43) Pub. Date: Jun. 22, 2017

(54) METHOD AND DEVICE FOR CORRELATING MULTIPLE TABLES IN A DATABASE ENVIRONMENT

(71) Applicant: Viktor Charles Von Drakk, Geneva, IL (US)

(72) Inventor: Viktor Charles Von Drakk, Geneva, IL (US)

(21) Appl. No.: 15/382,347

(22) Filed: Dec. 16, 2016

Related U.S. Application Data
(60) Provisional application No. 62/269,954, filed on Dec. 19, 2015.

(51) Int. Cl. G06F 17/30

(52) U.S. Cl. CPC G06F 17/30339; G06F 17/3033; G06F 17/30002

(57) ABSTRACT

A system, process, and method for organizing unstructured data stored in a database environment with table structure such that the data is retrievable using relational set logic, even with a database environment that does not provide relational table structures, is disclosed. The method creates, updates, and deletes database objects as necessary to describe the relationships between disparate data object types for various unique values and to provide the necessary information to retrieve the desired data objects. A device embodying and enabling the practice of the method is also disclosed.

### PRIORITY CLAIM

This application claims priority from one or more previously filed Provisional Patent application, namely:
U.S. Provisional Patent Application Ser. 62/269,954, “System, process, and method for organizing unstructured data such that the data is retrievable using relational set logic,” filed Dec. 19, 2015.

This invention relates to a method for correlating multiple sets of collected data (stored in a plurality of tables in a database environment) quickly and efficiently even if the tables are large and/or constantly updated. The invention allows searching for related information quickly and efficiently even if the tables are not actively structured, indexed, or related. The invention extends to a device which implements the method.

### BACKGROUND OF THE INVENTION

The present invention relates to searching large and/or constantly-updated tables containing data for particular correlations. It is especially useful for, though not limited to, searching multiple large tables for correlated information. It will be described in the context of searching tables of network activity and information for particular correlations which may indicate attempts to penetrate secure networks, establish means to penetrate secure networks at a later time or upon the occurrence of some other event, or otherwise evade computer security protections of various types. However, the problem it addresses is an old and general one in the art, as will be set forth below.

For purposes of this application, a database management system (“DBMS”) will be defined as computer software which creates an information storage environment operating on one or more general purpose or specially designed computer systems allowing the creation and manipulation of one or more digital files (“databases”) containing a plurality of tables, each table containing a plurality of records, each record containing a plurality of fields, and each field containing some specific piece of information.

As is well known to those of ordinary skill in the art, DBMS may be considered to belong to one of two general classes: relational systems, in which tables can be actively “related” to each other at the DBMS application level by designating one or more “related” fields common to the related tables, and nonrelational systems, in which no such relation can be actively maintained at the application level. (Nonrelational DBMS are also referred to as “flat-file” DBMS.)

An example of a relational database would be one containing a table with a list of names and addresses, and a table containing a list of names and birthdates. If the tables were ‘related’ by the name fields at the application level, it would be simple to have the DBMS search for all names associated with a particular birthdate, and use the address table to automatically prepare a personalized birthday greeting including a mailing address for each related name. If the tables were not related at the application level, first all names associated with a particular birthdate would have to be searched from the birthdate table and then the address table would have to be searched for each such name and an individual personalized birthday greeting prepared.

While tables in nonrelational DBMS can be manually related by choosing a suitable field from at least two tables and then performing individual operations on the tables relative to the common elements of those fields, the functionality of a relational DBMS, for purposes of this application, is part of the overhead of the computer software which creates, maintains, and accesses the DBMS. If two tables are related at the application level, the computer software will automatically maintain knowledge of the related elements, any search which involves the related tables will be made faster, and operations are supported which allow more complex manipulation of the related data with less effort on the part of the user. The tradeoff is that maintaining the relation(s) requires large amounts of resources which make the overall computer software slower and the file storage necessary greater.

Nonrelational DBMS, free of the overhead of maintaining the relationships and storing information about them at the application level, can be faster and the file storage requirements can be lower. Additional efficiencies are also possible due to the lack of restrictions that relational DBMS by necessity impose on related tables.

Similarly, tables in a DBMS may be “indexed” or “non-indexed.” An indexed table is one which contains at least one index field in every record, with the contents of that index field being unique to each record. (For instance, a table of items with serial numbers can use the item serial numbers as an index field, as serial numbers by definition are unique to individual items.) Indexing a table makes it faster and more efficient to sort or otherwise process in some ways, but imposes overhead, restrictions and file storage requirements which are not necessary for non-indexed tables.

It is an old problem in the art to select the parameters for the creation of DBMS such that they are relational or non-relational, and/or use indexed or non-indexed tables. Relational DBMS and indexed tables provide many advantages but as the amount of data in the table(s) in the database grows, the overhead, storage, and restrictions inherent in these features become much more burdensome. Modern network activity logs, for instance, can generate tables with millions of entries per day or even per hour, and are updated hundreds or thousands of times per second. The amount of data generated is large and the overhead associated with dynamically indexing it and maintaining relationships, if such is desired, is equally large.

It would be useful to provide a method for gaining some of the advantages that relational DBMS and/or indexed tables provide without requiring that the DBMS be actively relational and/or that the tables therein be dynamically indexed. The present invention addresses these concerns.

### SUMMARY OF THE INVENTION

Among the many objectives of the present invention is the provision of a method for organizing unstructured data stored in a non-relational DBMS such that the data is retrievable using relational set logic.

Another objective of the present invention is the provision of a method for rapidly and efficiently determining whether two or more tables contain corresponding data.

Another objective of the present invention is the provision of a method for efficiently monitoring tables containing unstructured data and performing a predetermined plurality of steps if data added to one table corresponds to data already present in another table.

Yet another objective of the present invention is the provision of a device which will automatically execute the method(s) of the invention and accept input from a user to execute the method(s) as directed by the user.

### BRIEF DESCRIPTION OF THE DRAWINGS

FIG. 1 depicts an abstract block diagram of a database with two tables and the configuration of those tables.

FIG. 2 depicts an example of a database containing two Data Tables and sample data sets which are stored in those Data Tables.

FIG. 3 depicts a process flow diagram of the method of the invention.

FIG. 4 depicts an abstract configuration specification for a database containing a Data Table and a Reference Table.

FIG. 5 depicts an example of a database containing two Data Tables and sample data sets which are stored in those Data Tables, and a Reference Table and the reference data stored in the Reference Table.

FIG. 6 depicts an abstract block schematic of a device which implements the method of the invention.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, may be used with respect to the drawings. These and similar directional terms are not to be construed to limit the scope of the invention in any manner. The words attach, connect, couple, and similar terms with their inflectional morphemes do not necessarily denote direct or intermediate connections, but may also include connections through mediate elements or devices.

For purposes of the description of the preferred embodiment(s), a DBMS running on a single “server,” or a single physical computer running a software application which provides the functionality of the DBMS, will be assumed. It is well known to those of ordinary skill in the relevant art that DBMS can be operated on “virtual” servers comprising a single instance of an operating system running contemporaneously with other instances of operating systems on a single physical computer, and/or on “clusters” comprising a plurality of actual or virtual servers, and/or that the data stored in the DBMS's database(s) may be stored on a plurality of separate servers or information storage devices which may or may not be integral to the server(s) running the DBMS software application.

Furthermore, many DBMS utilize a “client/server” configuration where some operations take place on the server running the DBMS software application and others take place on a separate computer or computers being operated by a user. Any or all of the devices involved in the configuration of the DBMS server(s) and/or clients may be physically proximate, connected remotely through wired or wireless networking, or virtually connected through the global computer network. The underlying configuration, location, and connection structure of the DBMS server(s) and/or any client computers and/or any information storage devices are irrelevant for the purposes of the invention, and any reasonable configuration desired and implemented by a person of ordinary skill in the relevant art will serve to perform the method of the invention or serve as a device for its implementation.

For purposes of the description of the preferred embodiment, a single unlimited database object, created and maintained by a DBMS running on the server, which allows for the creation of two or more tables will be assumed. Each of the tables will contain a plurality of records, each of which contains a plurality of fields, each field containing a single stored piece of information. These records can comprise delimited lines in a text file, delimited objects (for example, JSON objects) in a text file, individual data objects in an appropriate digital “container,” or any other desired format.

The following tables will be assumed to be defined and, where appropriate, dynamically maintained as new information appropriate for storage within those tables becomes available. The fields defined as “included” are required, but additional fields can be added without affecting the basic operation of the method.

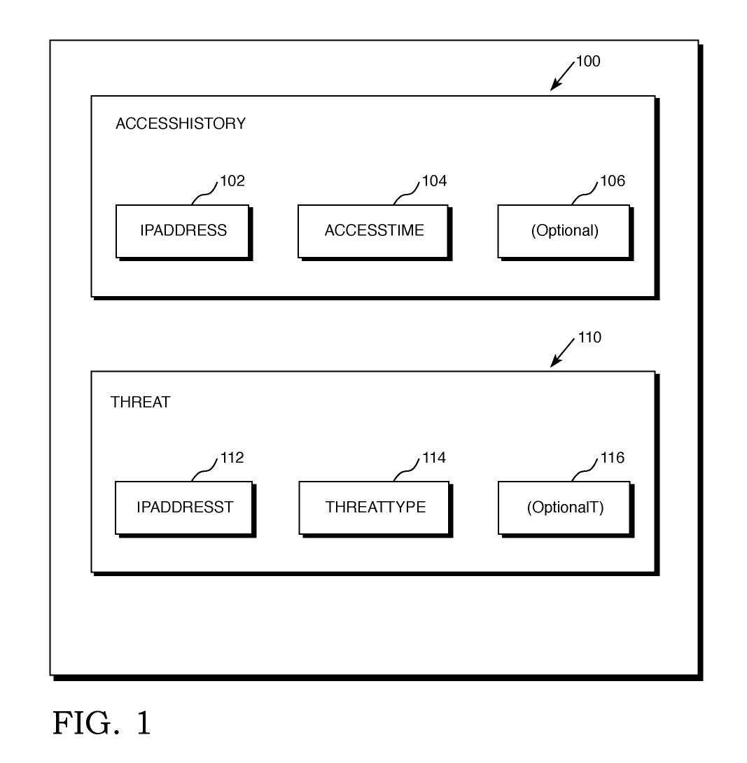

By referring to FIG. 1, the basic structure of each table can be easily understood. The first table is ACCESSHISTORY 100, which includes fields IPADDRESS 102, ACCESSTIME 104, and any optional fields if desired (labeled as Optional 106, though more than one optional field may be used.) The second table is THREATS 110, which includes fields TIPADDRESS 112, THREATTYPE 114, and any optional fields if desired (labeled as OptionalT 116, though more than one optional field may be used.)

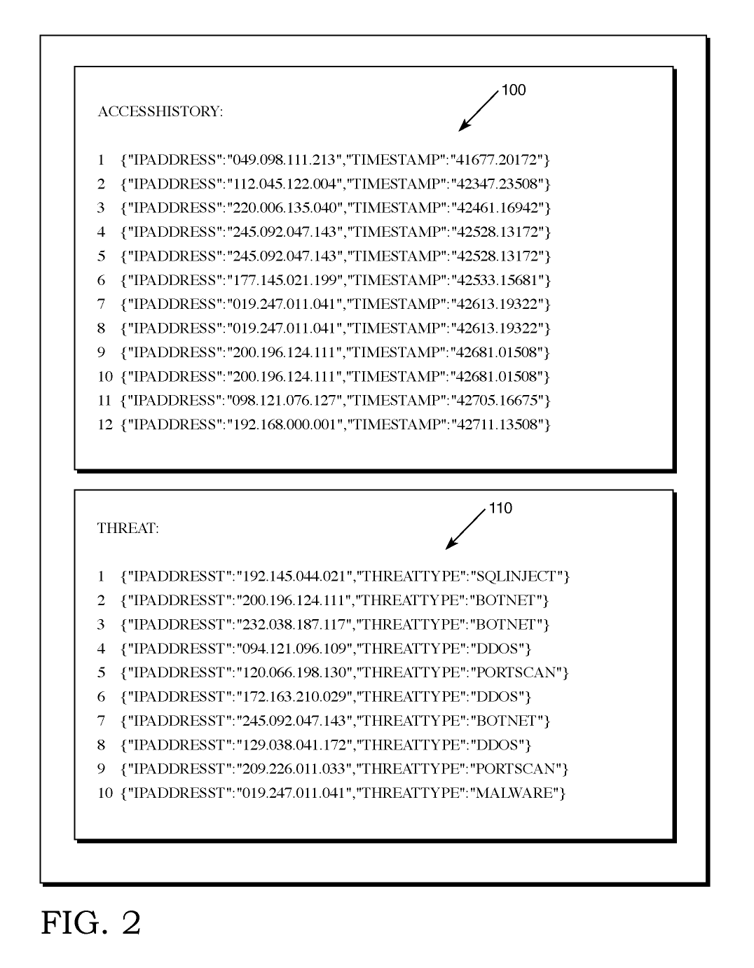

FIG. 2 shows an example of both ACCESSHISTORY 100 and THREAT 110 with representative data. It is required that the computer file(s) containing both ACCESSHISTORY 100 and THREAT 110 be a text file or otherwise comprise a means of storing a plurality of key-value pairs (where each record of the table comprises a plurality of values and each individual value stored in that record is associated with a single key.) For purposes of demonstration, only the material within curly brackets (“{” and “}”) should be considered to be included in the actual file: the line numbers are for ease of reference.

ACCESSHISTORY 100 contains multiple records. Each record contains an IP address and a decimal number comprising a timestamp. Each IP address is paired with the key IPADDRESS and each timestamp is paired with the key TIMESTAMP. THREAT 110 contains multiple records. Each record contains an IP address and an arbitrary text string comprising a threat type identifier. Each IP address is paired with the key IPADDRESST and each threat type identifier is paired with the key THREATTYPE.

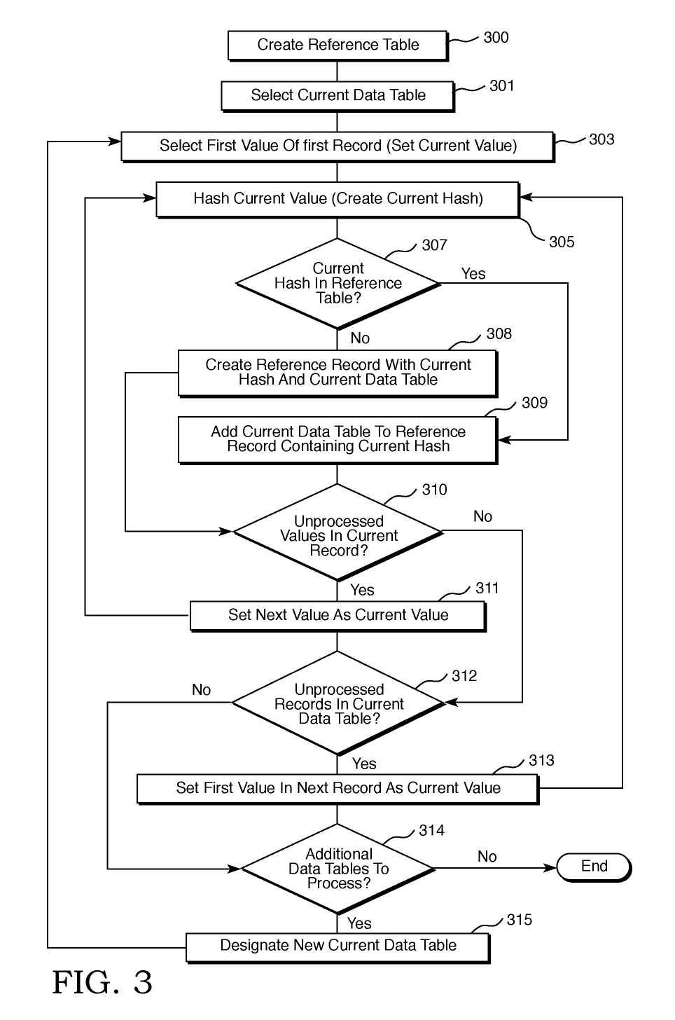

FIG. 3 shows the practice of the base method of the invention which comprises a series of steps which allow tables such as ACCESSHISTORY and THREAT to be quickly and efficiently correlated and/or searched even if they are maintained in a non-relational DBMS with limited indexing and/or structure.

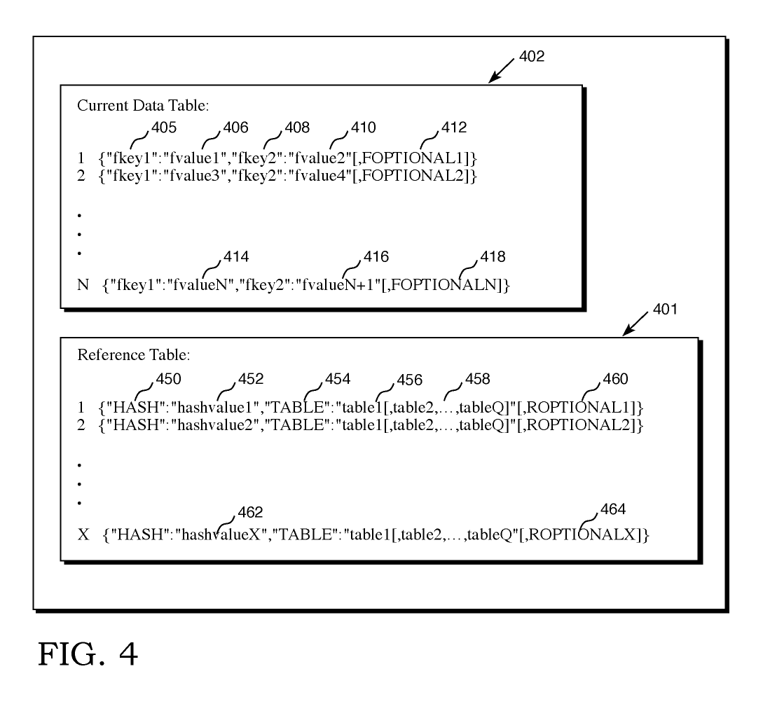

In Reference Data Table Creation Step 300, a Reference Table 401 (See FIG. 4) is created which can store reference data in the form of records comprising a plurality of key-value pairs. The structure and function of the records in Reference Table 401 will become apparent as the method is described. It should be noted that any step in this method which requires the creation of a table is equivalent to selecting a pre-existing table which may or may not already be populated with data, and vice-versa. It is required that if a pre-existing table is selected, any data it is already populated with does not contain inaccuracies related to the way the method tracks tables as containing or not containing any particular value. It is preferred to create a new Reference Table when the method is implemented in any particular DBMS application. It is required that any table which is to be hashed (see below) contains at least one value in at least one record before it is hashed.

In Current Data Table Selection Step 301, a Current Data Table 402 (See FIG. 4) is selected which has a plurality of records, each containing a plurality of key-value pairs stored in Data Table fields. In Current Data Table Initialization Step 303, the first value in the first record of Current Data Table 402 (See FIG. 4) is selected for processing. The value selected for processing will be referred to herein as the “current value.”

In Current Table Hashing Step 305, the selected value in Current Data Table 402 is “hashed.” Hashing, as is known to persons of ordinary skill in the art, is the act of processing a known value (e.g. a number or a string of text) through a defined hashing algorithm and obtaining a resultant hash value. In this case, the well-known MD5 hash algorithm is used. This algorithm produces hash values (or simply a “hash”) of uniform length and format no matter the length of the initial input, which is strongly preferred, although any algorithm producing similar results will satisfy the preference. The output of this step is the “current hash.”

In Current Hash Check Step 307, the Reference Table 401 is checked to see if a record exists which contains the current hash. If it does not, a record is created and the current hash is added to it, along with a reference to Current Data Table 402 in that record. If it does, a reference to Current Data Table 402 is added to the record which contains the current hash. At the end of this step, Reference Table 401 will contain a record which contains a) the hash value of the selected value, and b) a reference to Current Data Table 402 associated with that hash value. It is optional to include additional information in the record in Reference Table 401 related to the current value. As an example, if the current value is an IP address from which some threat to security is known to originate, a designation of such threat type could be included. If this were done, at the end of all processing, the record with the hash value of that IP address would contain a reference to all tables containing it and all threat types associated with it in any of those tables.

It should be noted that while Current Table Hashing Step 305 and Current Hash Check Step 307 are strongly preferred, they are not required. Hashing the values before storing them in Reference Table 401 provides for efficiency and consistency. However, the current value can be stored in Reference Table 401 as readily as the current hash. It is only required that the conditions set forth below regarding the final content of Reference Table 401 be true with regard to reference values (the current values stored rather than current hashes) rather than with regard to reference hashes.

In Current Value Continue Check Step 309 it is determined whether the current record selected for processing contains any unprocessed values. If so, the next value in the record is selected for processing and the method returns to Current Table Hashing Step 305. If not, the method continues.

In Current Table Record Continue Check Step 311, it is determined whether Current Data Table 402 contains any records which have not yet been processed. If so, the next record in Current Data Table 402 is selected for processing and the method returns to Current Data Table Hashing Step 305. If not, the method continues.

In Additional Table Continue Check Step 313, which is reached only when all records in Current Data Table 402 have been processed and their hashes and accompanying references to Current Data Table 402 have been added to Reference Table 401, it is determined whether there are additional data tables to process. If so, the next data table to be processed is designated the new Current Data Table, and the method returns to Current Data Table Initialization Step 303. If not, the method ends.

It is required that there be at least one additional data table to process, as the method of the invention improves searching multiple data tables for corresponding information. However, there is no limit on how many data tables the method can process.

At the end of the method, Reference Table 401 will contain a plurality of records, each containing a single hash value (each such hash value in Reference Table 401 a “reference hash,”) and a value containing a reference to one or more data tables. For every unique value appearing in any and all processed data tables, there will be a single record, containing the equivalent reference hash, in Reference Table 401, no matter how many times that value may appear in any given data table or in all data tables. That record will include references to every data table which contains the value associated with that reference hash and any optional additional information, such as whether that value (if an IP address) is associated with any threat types.

FIG. 4 shows the general format and structure of a representative data table, Current Data Table 402, and a representative reference table, Reference Table 401. Both tables are set up as text files containing data objects in the JSON format. (As above, only materials in curly brackets are part of the table: the first column of line numbers is only for reference.)

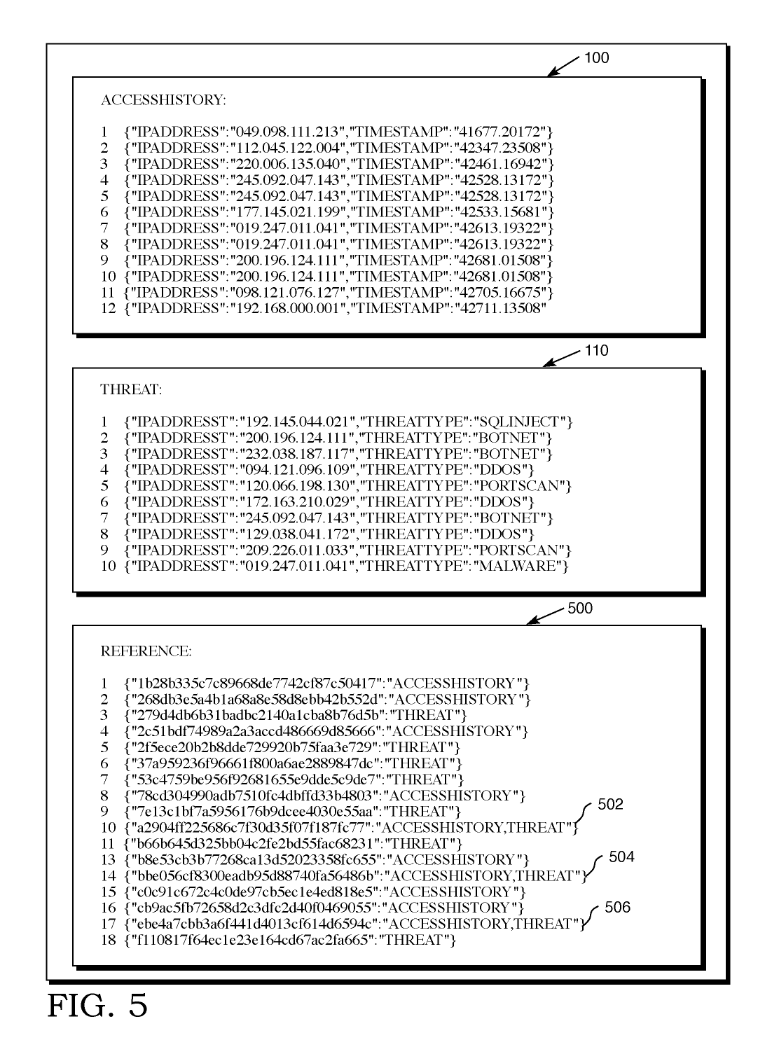

Referring to FIG. 5, a representative Reference Table produced by processing the tables of FIG. 2 may be seen. The representative Reference Table will comprise a plurality of Reference Table records, each Reference Table record comprising a plurality of Reference Table record fields, each Reference Table record field storing a Reference Table record field value. Table ACCESSHISTORY 100 and table THREAT 110 (as seen in FIG. 2) have been processed with the method to produce table REFERENCE 500. (As before, only the material in curly brackets is to be considered part of the table: the line numbers in the first column are for reference.) Each record of REFERENCE 500, represented by a single line, contains a hash of an IP address. For each unique IP address in both ACCESSHISTORY 100 and THREAT 110, a single record with a hash of that IP address appears in REFERENCE 500. In that record is a reference to all the tables which contain that corresponding IP address.

A search for correspondences in ACCESSHISTORY and THREAT, which in an ordinary non-relational DBMS would require multiple iterative searches of the tables as separate collections of data, may now be done simply by searching REFERENCE. First dual entry record 502, second dual entry record 504, and third dual entry record 506 represent records in which an IP address appears in both ACCESSHISTORY 110 and THREAT 110. In an example where a search for accesses from locations identifies as threats was performed, searching REFERENCE 500 for records containing a reference to both of those tables would return those records.

It should be noted that only the IP address values were processed to produce REFERENCE 500 by way of illustration. In a full implementation of the method, all values would be processed to allow for searching REFERENCE for any desired type of value or for combinations of values.

As the number of data tables processed to create REFERENCE 500 increases, the efficiency of such searching will continue to increase. If there were three tables, finding out if a value appeared in all three, or in any two but not all three, or in one but not any other two, would require multiple iterative searches in a non-relational DBMS. With the method, searching REFERENCE 500 for values which meet the desired parameters is trivial. Once done, the results of the search will tell the searcher which tables may be searched to find corresponding individual records.

When all values in a plurality of tables have been processed and added to a Reference Table, every unique value in each of those tables (or, if preferred, the values and/or types of values upon which searches are likely to be done) will appear in the Reference Table, exactly once, as a reference hash (or, if preferred, as a single instance of the value.) Each of these reference hashes will be associated with a Data Table, wherein the searcher can, if desired, search for the occurrence(s) of the value. In many cases it can be sufficient for the searcher's purpose to quickly and efficiently determine that a value is located within a particular Data Table (e.g. that an IP Address appears in a THREAT table of known sources of network security threats.)

As set forth above, once the method has been practiced on multiple data tables, it will be apparent to a person of ordinary skill in the art that the Reference Table thus created allows searching any and all of the processed data tables for information about values they contain and/or information about values found in multiple tables by searching a single table—namely, the Reference Table. However, absent the teaching of the invention, it would not be apparent to a person of ordinary skill in the art that such a search could be implemented in the quick and efficient method enabled by the invention.

Without changing the underlying method of the invention, additional steps, including but not limited to the following, could be added. The combination of the method as thus far described with the steps set forth below, even if the additional steps happen to be known in the prior art as individual actions, results in an overall method which is novel and addresses the objectives of the invention in a new and unanticipated way.
1) A user can either manually or through automated means initiate a search for any particular value (“search value”) which may be located in any of the Data Tables which have been processed. That search need only search the Reference Table and it will return any and all tables which contain the search value. If additional data about the values has been stored (For instance, if the value was present in a THREAT table, the type of the threat associated with the value, if any, can be stored in an optional field in the Reference table.) The additional data can be provided to the user either by default or upon request. The user can then search each of the tables associated with the search data if further information is required about the information stored in association with the search value.
2) Whenever new data is added to a Data Table, the hash value (or if preferred, the value itself) along with a reference to the Data Table and any optional additional data can be added to the Reference Table as a single operation, allowing for highly efficient dynamic indexing of all new data in a database without requiring the maintenance of formal relationships or unique indexing fields in any table.
3) Since the method requires that any new data be checked for uniqueness relative to all processed Data Tables, it is trivial to notify either human beings, automated monitoring processes, or both, when novel data is added to a particular Data Table in a database by including such notification in the step where the new reference hash is added to the Reference Table. By adding a step checking an existing reference hash (or if preferred, an existing reference value) for associations with the Data Table the new data is being added to, it is also trivial to monitor individual Data Tables for the addition of data which is novel to the individual Data Table.
4) If, for example, the invention is being used to monitor a table of threat sources such as known bad IP addresses, if a value is added to an ACCESSTABLE table, the DBMS can be configured such that the check for the existence of a unique reference hash (or if preferred, reference value) will also perform a secondary step notifying any and all human users desired via email (or other messaging means) that a reference hash (or if preferred, reference value) has been generated which associates a new ACCESSTABLE entry with a known THREAT entry.
5) Similarly, if the invention is being used to monitor a table of threat sources such as known bad IP addresses, if a value is added to a THREAT table, the DBMS can be configured such that the check for the existence of a unique reference hash (or if preferred, reference value) will also perform a secondary step sending automated monitoring processes or systems that a reference hash (or if preferred, reference value) has been generated which associates a new THREAT entry with a known ACCESSTABLE entry.
6) To expand on the above examples, after a notification is sent to a human being and/or an automated monitoring process or system when a new correlation appears (E.G. an old ACCESSTABLE entry is now correlated with a new THREAT table entry, or a new ACCESSTABLE table entry is correlated with a known THREAT table entry), the method may extend to either manual responses (on the part of a human being) or automatic responses (on the part of an automated monitoring process or system) which initiate predefined security protocols or methods, such as blocking access from an IP address which is now associated with a known threat, or searching a predefined range of logs for previously logged accesses from an IP address now known to be a potential threat.

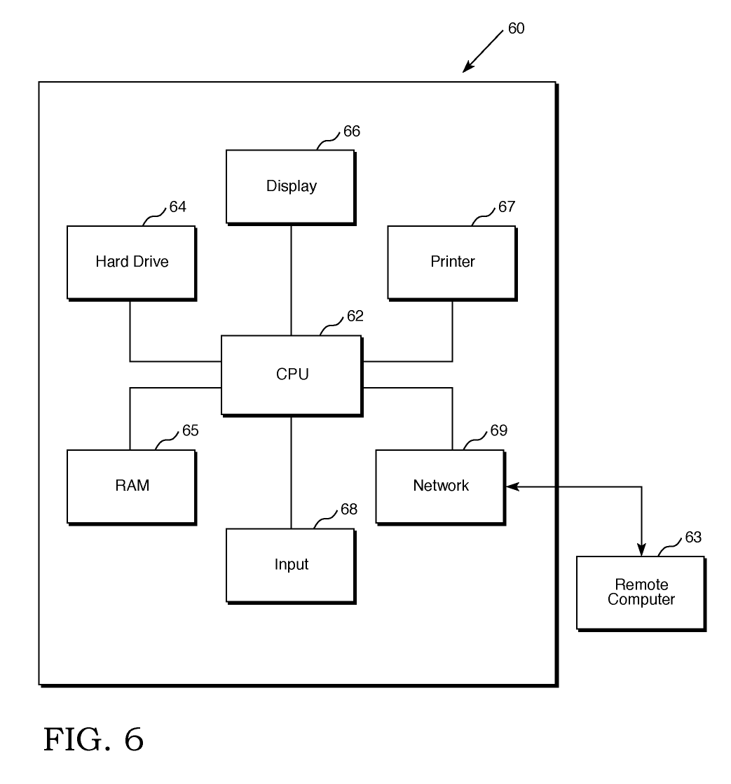

While the method may be implemented in any reasonable way, FIG. 6 depicts a device which implements the method such that a person of reasonable skill in the art could use such a device to automate part or all of the method.

Computer 60 comprises CPU 62, which executes instructions (such as the computer code for implementing a DBMS) stored in digital files. These files are stored in a persistent storage device such as Hard Drive 64, which can be a mechanical hard drive, a Flash RAM, or any other desired persistent storage device. They are read into RAM 65 by CPU 62, which obtains data stored in a database similarly contained in Hard Drive 64. A user inputs search commands, additional data, or other relevant input through Input Device 68, which can comprise a keyboard, a mouse, a scanner, a voice recognition unit, or any combination of these or other equivalent input means. Information stored on Hard Drive 64, along with interface screens and output information, can be displayed to the user on Display 66, which can comprise a CRT, an LED or LCD, or any other reasonable display means. In addition or alternatively, information can be provided by physical means such as Printer 67.

It is optional to store any part of the DBMS, including code, client application interfaces, server application interfaces, Data Tables or Reference Tables, remotely, for example in Remote Computer 63, which may be connected to Computer 60 via Network 69. Network 69 can comprise physical networking or cabling, wireless networking, or virtually through the global computer network.

As an example, and without limitation, a DBMS as described generally in FIG. 6 could include a Relational Object Engine and a Relational Lookup Engine. The Relational Object Engine creates, updates, and deletes a Reference Table (or Reference Tables) as necessary to track the relationships between disparate data stored in Data tables for various unique values and to provide the necessary information to retrieve the desired data. The Relational Lookup Engine can efficiently locate and retrieve document objects described by queries, optionally filtering the result set before retrieval and providing the results to the client.

In a preferred embodiment, the DBMS includes a Relational Organization Engine, a Relational Lookup Engine, an API, and a data storage system. The Relational Organization Engine examines Data tables and creates Reference Tables objects to describe relationships between data objects that vary in type but contain matching values or overlapping values, such as numeric ranges. The Reference Tables include the information necessary for the DBMS to retrieve the original data objects by means of searching the Data Tables which contain them. The Relational Lookup Engine processes search values to find matching reference values, finds all Data Tables which contain the reference value(s) corresponding to the search value, and then optionally retrieves and/or processes the values stored in the Data Tables.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1. A method for correlating multiple tables in a database environment comprising the steps of:
a) Initiating a computer software application comprising a database management system application capable of creating at least three tables including at least two data tables and at least one reference table, the at least three tables each having a unique corresponding table identifier and the at least three tables including:
i. a first data table comprising a plurality of first data table records, the plurality of first data table records comprising a plurality of first data table fields, the plurality of first data table fields having a plurality of associated first data table field names and the plurality of first data table fields storing a plurality of first data table field values;
ii. a second data table comprising a plurality of second data table records, the plurality of second data table records comprising a plurality of second data table fields, the plurality of second data table fields having a plurality of associated second data table field names and the plurality of second data table fields storing a plurality of second data table field values; and,
iii. a reference table,
initiating the computer software application comprising running the computer software application on a computer;
b) Creating a first reference table in the database management system, the first reference table comprising a plurality of first reference table records, the plurality of first reference table records comprising a plurality of first reference table fields, the plurality of first reference table fields including a first reference value field and a first table association field;
c) Designating the first data table as the current data table;
d) Designating a first data table record as the current data record;
e) Designating a current value as the first data table field value of the first data table record of the first data table;
f) Searching the first reference table to determine whether the current value is present in the first reference value field of any of the plurality of first reference table records;
g) Adding a new first reference table record to the first reference table, storing the current value in the first reference value field, and storing the unique corresponding table identifier of the current data table in the first table association field of the new first reference table record if the current value is not present in the first reference value field of any of the plurality of first reference table records;
h) Appending the unique corresponding table identifier of the current data table to the first table association field of the first reference table record containing the current value if the current value is present in the first reference value field of any of the plurality of first reference table records;
i) Determining whether the current data record contains any values for which the first reference table has not been searched and if so, selecting a next value from the current data record for which the first reference table has not been searched as the current value and returning to step (f), otherwise moving to the next step;
j) Determining whether the current data table contains any records containing any values for which the first reference table has not been searched and if so, designating a next current data record from the current data table containing at least one value for which the first referenced table has not been searched and designating a current data value in the next current data record as the current value and returning to step (f), otherwise moving to the next step;
k) Determining whether any of the plurality of data tables contain any records containing any values for which the first reference table has not been searched, and if so designating a next data table containing at least one value for which the first reference table has not been searched as the current data table, designating a next current data record from the current data table containing at least one value for which the first reference table has not been searched, designating a data value in the next current data record as the current value and returning to step (f), otherwise ending the method.

2. A method for correlating multiple tables in a database environment as in claim 1, wherein the database management system application does not support the creation and maintenance of relationships between corresponding fields in at least two tables at the application level.

3. A method for correlating multiple tables in a database environment comprising the steps of:
a) Initiating a computer software application comprising a database management system application capable of creating at least three tables including at least two data tables and at least one reference table, the at least three tables each having a unique corresponding table identifier and the at least three tables including:
i. a first data table comprising a plurality of first data table records, the plurality of first data table records comprising a plurality of first data table fields, the plurality of first data table fields having a plurality of associated first data table field names and the plurality of first data table fields storing a plurality of first data table field values;
ii. a second data table comprising a plurality of second data table records, the plurality of second data table records comprising a plurality of second data table fields, the plurality of second data table fields having a plurality of associated second data table field names and the plurality of second data table fields storing a plurality of second data table field values; and,
iii. a reference table,
initiating the computer software application comprising running the computer software application on a computer;
b) Creating a first reference table in the database management system, the first reference table comprising a plurality of first reference table records, the plurality of first reference table records comprising a plurality of first reference table fields, the plurality of first reference table fields including a first reference value field and a first table association field;
c) Designating the first data table as the current data table;
d) Designating a first data table field record as the current data record;
e) Designating a current value as the first data table field value of the first data table record of the first data table;
f) Defining a hash value by applying a hashing algorithm to the current value;
g) Searching the first reference table to determine whether the hash value is present in the first reference value field of any of the plurality of first reference table records;
h) Adding a new first reference table record to the first reference table, storing the current hash in the first reference value field, and storing the unique corresponding table identifier of the current data table in the first table association field of the new first reference table record if the hash value is not present in the first reference value field of any of the plurality of first reference table records;
i) Appending the unique corresponding table identifier of the current data table to the first table association field of the first reference table record containing the hash value if the hash value is present in the first reference value field of any of the plurality of first reference table records;
j) Determining whether the current data record contains any values which have not been hashed and if so, selecting a next value from the current data record which has not been hashed as the current value and returning to step (f), otherwise moving to the next step;
k) Determining whether the current data table contains any records containing any values which have not been hashed and if so, designating a next current data record from the current data table containing at least one unhashed value and designating an unhashed data value in the next current data record as the current value and returning to step (f), otherwise moving to the next step;
l) Determining whether any of the plurality of data tables contain any records containing any values which have not been hashed, and if so designating a next data table containing at least one unhashed value as the current data table, designating a next current data record from the current data table containing at least one unhashed value and designating an unhashed data value in the next current data record as the current value and returning to step (f), otherwise ending the method.

4. A method for correlating multiple tables in a database environment as in claim 3, wherein the database management system application does not support the creation and maintenance of relationships between corresponding fields in at least two tables at the application level.

5. A device for correlating multiple tables in a database environment comprising:
a) a digital computer comprising a CPU, a RAM and/or a persistent storage device, an input device, and a visual display, the RAM and/or the persistent storage device, the input device, and the visual display operably connected to the CPU;
b) a database management system application stored on the persistent storage device;
c) at least three tables including at least two data tables and at least one reference table, the at least three tables being stored on the persistent storage device and each having a unique corresponding table identifier, the at least three tables including:
i. a first data table comprising a plurality of first data table records, the plurality of first data table records comprising a plurality of first data table fields, the plurality of first data table fields having a plurality of associated first data table field names and the plurality of first data table fields storing a plurality of first data table field values;
ii. a second data table comprising a plurality of second data table records, the plurality of second data table records comprising a plurality of second data table fields, the plurality of second data table fields having a plurality of associated second data table field names and the plurality of second data table fields storing a plurality of second data table field values; and,
iii. a reference table comprising a plurality of first reference table records, the plurality of first reference table records comprising a plurality of first reference table fields, the plurality of first reference table fields including a first reference value field and a first table association field;
d) a database management program file stored on the RAM and/or the persistent storage device, the database management program file comprising a set of instructions which are executed by the CPU and cause the database management system application to perform the following operations;
i. Designate the first data table as the current data table;
ii. Designate a first data table record as the current data record;
iii. Designate a current value as the first data table field value of the first data table record of the first data table;
iv. Search the first reference table to determine whether the current value is present in the first reference value field of any of the plurality of first reference table records;
v. Add a new first reference table record to the first reference table, storing the current value in the first reference value field, and storing the unique corresponding table identifier of the current data table in the first table association field of the new first reference table record if the current value is not present in the first reference value field of any of the plurality of first reference table records;
vi. Append the unique corresponding table identifier of the current data table to the first table association field of the first reference table record containing the current value if the current value is present in the first reference value field of any of the plurality of first reference table records;
vii. Determine whether the current data record contains any values for which the first reference table has not been searched and if so, selecting a next value from the current data record for which the first reference table has not been searched as the current value and returning to step (iv), otherwise moving to the next step;
viii. Determine whether the current data table contains any records containing any values for which the first reference table has not been searched and if so, designating a next current data record from the current data table containing at least one value for which the first referenced table has not been searched and designating a current data value in the next current data record as the current value and returning to step (iv), otherwise moving to the next step;
ix. Determine whether any of the plurality of data tables contain any records containing any values for which the first reference table has not been searched, and if so designating a next data table containing at least one value for which the first reference table has not been searched as the current data table, designating a next current data record from the current data table containing at least one value for which the first reference table has not been searched, designating a data value in the next current data record as the current value and returning to step (iv), otherwise wait for a plurality of further instructions or act upon a plurality of predetermined further instructions.

6. A device for correlating multiple tables in a database environment as in claim 5, wherein the database management system application does not support the creation and maintenance of relationships between corresponding fields in at least two tables at the application level.

7. A device for correlating multiple tables in a database environment comprising:
a) a digital computer comprising a CPU, a RAM and/or a persistent storage device, an input device, and a visual display, the RAM and/or the persistent storage device, the input device, and the visual display operably connected to the CPU;
b) a database management system application stored on the persistent storage device;
c) at least three tables including at least two data tables and at least one reference table, the at least three tables being stored on the persistent storage device and each having a unique corresponding table identifier, the at least three tables including:
i. a first data table comprising a plurality of first data table records, the plurality of first data table records comprising a plurality of first data table fields, the plurality of first data table fields having a plurality of associated first data table field names and the plurality of first data table fields storing a plurality of first data table field values;
ii. a second data table comprising a plurality of second data table records, the plurality of second data table records comprising a plurality of second data table fields, the plurality of second data table fields having a plurality of associated second data table field names and the plurality of second data table fields storing a plurality of second data table field values; and,
iii. a reference table comprising a plurality of first reference table records, the plurality of first reference table records comprising a plurality of first reference table fields, the plurality of first reference table fields including a first reference value field and a first table association field;
d) a database management program file stored on the RAM and/or the persistent storage device, the database management program file comprising a set of instructions which are executed by the CPU and cause the database management system application to perform the following operations;
i. Designate the first data table as the current data table;
ii. Designate a first data table field record as the current data record;
iii. Designate a current value as the first data table field value of the first data table record of the first data table;
iv. Define a hash value by applying a hashing algorithm to the current value;
v. Search the first reference table to determine whether the hash value is present in the first reference value field of any of the plurality of first reference table records;
vi. Add a new first reference table record to the first reference table, storing the current hash in the first reference value field, and storing the unique corresponding table identifier of the current data table in the first table association field of the new first reference table record if the hash value is not present in the first reference value field of any of the plurality of first reference table records;
vii. append the unique corresponding table identifier of the current data table to the first table association field of the first reference table record containing the hash value if the hash value is present in the first reference value field of any of the plurality of first reference table records;
viii. Determine whether the current data record contains any values which have not been hashed and if so, selecting a next value from the current data record which has not been hashed as the current value and returning to step (iv), otherwise moving to the next step;
ix. Determine whether the current data table contains any records containing any values which have not been hashed and if so, designating a next current data record from the current data table containing at least one unhashed value and designating an unhashed data value in the next current data record as the current value and returning to step (iv), otherwise moving to the next step;
x. Determine whether any of the plurality of data tables contain any records containing any values which have not been hashed, and if so designating a next data table containing at least one unhashed value as the current data table, designating a next current data record from the current data table containing at least one unhashed value and designating an unhashed data value in the next current data record as the current value and returning to step (iv), otherwise wait for a plurality of further instructions or act upon a plurality of predetermined further instructions.

8. A device for correlating multiple tables in a database environment as in claim 7, wherein the database management system application does not support the creation and maintenance of relationships between corresponding fields in at least two tables at the application level.
